(19) United States
(12) Patent Application Publication
(10) Pub. No.: US 2024/0199922 A1
(43) Pub. Date: Jun. 20, 2024

(54) ENERGY RAY-CROSSLINKABLE ADHESIVE AGENT COMPOSITION, CROSSLINKED ADHESIVE AGENT, ADHESIVE SHEET, AND METHODS FOR PRODUCING SAME

(71) Applicant: LINTEC CORPORATION, Itabashi-ku (JP)

(72) Inventors: Kenta YAMAZAKI, Saitama-shi (JP); Shinya SUZUKI, Toda-shi (JP)

(73) Assignee: LINTEC CORPORATION, Itabashi-ku (JP)

(21) Appl. No.: 18/556,812

(22) PCT Filed: Apr. 26, 2021
(86) PCT No.: PCT/JP2021/016670

§ 371 Date: Oct. 23, 2023

(51) Int. Cl. C09J 7/38; C09J 11/08

(52) U.S. Cl. CPC C09J 7/385; C09J 11/08; C09J 2301/302; C09J 2301/408; C09J 2301/416; C09J 2425/00; C09J 2433/00; C09J 2461/00; C09J 2493/00

(57) ABSTRACT

An energy-beam-crosslinkable pressure sensitive adhesive composition, including an acrylic resin (A) having energy beam crosslinkability, and a tackifier (B). The tackifier (B) contains a styrene-based resin (B1). A pressure sensitive adhesive sheet including an energy-beam-crosslinkable pressure sensitive adhesive composition layer containing the energy-beam-crosslinkable pressure sensitive adhesive composition on a substrate or a release liner.

### TECHNICAL FIELD

The present invention relates to an energy-beam-crosslinkable pressure sensitive adhesive composition, a crosslinked pressure sensitive adhesive, and a pressure sensitive adhesive sheet, as well as methods for producing these.

### BACKGROUND ART

Pressure sensitive adhesive sheets are used in a wide range of industrial fields, for example, label applications for displaying various types of information; applications for fixing or temporarily fixing various components in fields such as office automation equipment, household electrical appliances, automobiles, and construction; and masking applications.

Synthetic rubber pressure sensitive adhesives can be designed to have a wide range of pressure sensitive adhesion properties by molecular design and combination with an additive, such as a tackifier, and are relatively inexpensive, and thus are widely used as pressure sensitive adhesives for pressure sensitive adhesive sheets. In addition, synthetic rubber pressure sensitive adhesives can be used as hot-melt pressure sensitive adhesives that can be applied to substrates or the like by heat-melting without using a solvent and thus have an advantage of being able to reduce the environmental load in producing pressure sensitive adhesive sheets.

For example, a block copolymer, such as a styrene-isoprene-styrene (SIS) block copolymer, is used as a base resin for synthetic rubber pressure sensitive adhesive. In SIS, a soft segment composed of a polyisoprene block contributes to the peel strength, and at or around normal temperature, a hard segment composed of a polystyrene block forms a physical pseudo crosslinking point by intermolecular forces and can exhibit sufficient strength. On the other hand, the pseudo-crosslinking point has a property of unraveling in high-temperature environments. Thus, the cohesive strength of a pressure sensitive adhesive obtained using SIS is significantly reduced by heating, and the pressure sensitive adhesive melts when the temperature exceeds a certain level. This melting property can be advantageous in that such a pressure sensitive adhesive can be used as a hot-melt pressure sensitive adhesive, but on the other hand, the property also becomes a factor that reduces the heat resistance as a pressure sensitive adhesive.

Patent Document 1 discloses a radiation-curable hot-melt adhesive composition containing: an acrylic polymer to which a photoinitiator is attached; a long-chain alkyl acrylate monomer containing an alkyl group having 6 or more carbons; a compatible tackifier; and a polyfunctional unsaturated oligomer.

### CITATION LIST

### Patent Literature

Patent Literature 1: WO 2008/057488

### SUMMARY OF INVENTION

### Technical Problem

The adhesive composition of Patent Document 1 can be applied in a melted state and undergoes a crosslinking reaction by irradiation with ultraviolet light and thus can improve the cohesive strength of the pressure sensitive adhesive. However, the effect is limited, and further improvement is required to enable the use of hot-melt pressure sensitive adhesives in wider applications and in various environments.

The present invention has been made in view of the above problems, and an object of the present invention is to provide an energy-beam-crosslinkable pressure sensitive adhesive composition capable of forming a pressure sensitive adhesive with good peel strength and excellent holding power: a pressure sensitive adhesive sheet obtained using the energy-beam-crosslinkable pressure sensitive adhesive composition; a crosslinked pressure sensitive adhesive obtained by energy beam crosslinking the energy-beam-crosslinkable pressure sensitive adhesive composition and a method for producing the crosslinked pressure sensitive adhesive; and a pressure sensitive adhesive sheet obtained using the crosslinked pressure sensitive adhesive and a method for producing the pressure sensitive adhesive sheet.

### Solution to Problem

The present inventors have found that the above problems can be solved by using an acrylic resin having a specific structure and a tackifier, and have completed the present invention.

That is, the present invention relates to [1] to below.
[1] An energy-beam-crosslinkable pressure sensitive adhesive composition containing:
an acrylic resin (A) having energy beam crosslinkability, and;
a tackifier (B), wherein
the tackifier (B) contains a styrene-based resin (B1).
[2] The energy-beam-crosslinkable pressure sensitive adhesive composition according to [1] above, wherein a content of the styrene-based resin (B1) is from 1 to 40 parts by mass per 100 parts by mass of the acrylic resin (A) having energy beam crosslinkability.
[3] The energy-beam-crosslinkable pressure sensitive adhesive composition according to [1] or [2] above, wherein the tackifier (B) further contains one or more selected from the group consisting of a hydrogenated terpene phenolic resin (B2) and a hydrogenated rosin-based resin (B3).
[4] The energy-beam-crosslinkable pressure sensitive adhesive composition according to [3] above, wherein a content of the one or more selected from the group consisting of the hydrogenated terpene phenolic resin (B2) and the hydrogenated rosin-based resin (B3) is from 1 to 39 parts by mass per 100 parts by mass of the acrylic resin (A) having energy beam crosslinkability.
[5] The energy-beam-crosslinkable pressure sensitive adhesive composition according to any of [1] to [4] above, wherein a total content of the tackifier (B) is from 5 to 40 parts by mass per 100 parts by mass of the acrylic resin (A) having energy beam crosslinkability.
[6] The energy-beam-crosslinkable pressure sensitive adhesive composition according to any of [1] to [5] above, wherein the acrylic resin (A) having energy beam crosslinkability is an acrylic resin having a benzophenone structure in a side chain.
[7] The energy-beam-crosslinkable pressure sensitive adhesive composition according to any of [1] to [6] above, wherein the styrene-based resin (B1) is a homopolymer of styrene-based monomers.
[8] A pressure sensitive adhesive sheet having an energy-beam-crosslinkable pressure sensitive adhesive composition layer composed of the energy-beam-crosslinkable pressure sensitive adhesive composition described in any of [1] to [7] above on a substrate or a release liner.
[9] A method for producing the pressure sensitive adhesive sheet described in [8] above, wherein
the energy-beam-crosslinkable pressure sensitive adhesive composition is obtained by melt-kneading the acrylic resin (A) having energy beam crosslinkability and the tackifier (B); and
the energy-beam-crosslinkable pressure sensitive adhesive composition layer is formed by applying the energy-beam-crosslinkable pressure sensitive adhesive composition in a melted state on the substrate or the release liner.
[10] A crosslinked pressure sensitive adhesive obtained by irradiating the energy-beam-crosslinkable pressure sensitive adhesive composition described in any of [1] to [7] above with an energy beam.
[11] The crosslinked pressure sensitive adhesive according to [10] above, wherein a gel fraction is from 30 to 85 mass %.
[12] The crosslinked pressure sensitive adhesive according to [10] or [11] above, wherein a haze measured in accordance with JIS K 7136: 2000 is 8% or less.
[13] A method for producing the crosslinked pressure sensitive adhesive described in any of [10] to [12] above, the method including:
irradiating the energy-beam-crosslinkable pressure sensitive adhesive composition with an energy beam.
[14] A pressure sensitive adhesive sheet having a pressure sensitive adhesive layer composed of the crosslinked pressure sensitive adhesive described in any of to [12] above on a substrate or a release liner.
[15] A method for producing the pressure sensitive adhesive sheet described in [14] above, the method including:
forming an energy-beam-crosslinkable pressure sensitive adhesive composition layer composed of the energy-beam-crosslinkable pressure sensitive adhesive composition on the substrate or the release liner; and
irradiating the energy-beam-crosslinkable pressure sensitive adhesive composition layer with an energy beam.
[16] The method for producing the pressure sensitive adhesive sheet according to [15] above, wherein
the energy-beam-crosslinkable pressure sensitive adhesive composition is obtained by melt-kneading the acrylic resin (A) having energy beam crosslinkability and the tackifier (B), and
the energy-beam-crosslinkable pressure sensitive adhesive composition layer is formed by applying the energy-beam-crosslinkable pressure sensitive adhesive composition in a melted state on the substrate or the release liner.

### Advantageous Effects of Invention

According to the present invention, there can be provided an energy-beam-crosslinkable pressure sensitive adhesive composition capable of forming a pressure sensitive adhesive with good peel strength and excellent holding power: a pressure sensitive adhesive sheet obtained using the energy-beam-crosslinkable pressure sensitive adhesive composition: a crosslinked pressure sensitive adhesive obtained by energy beam crosslinking the energy-beam-crosslinkable pressure sensitive adhesive composition and a method for producing the crosslinked pressure sensitive adhesive: and the pressure sensitive adhesive sheet obtained using the crosslinked pressure sensitive adhesive and a method for producing the pressure sensitive adhesive sheet.

### BRIEF DESCRIPTION OF DRAWINGS

FIG. 1 is a schematic cross-sectional view illustrating an example of a configuration of a pressure sensitive adhesive sheet of the present invention.

FIG. 2 is a schematic cross-sectional view illustrating another example of a configuration of a pressure sensitive adhesive sheet of the present invention.

FIG. 3 is a schematic cross-sectional view illustrating another example of a configuration of a pressure sensitive adhesive sheet of the present invention.

### DESCRIPTION OF EMBODIMENTS

In the present specification, the lower and upper limits of a preferred numerical range (e.g., a range of content or the like) described step-by-step can each be independently combined. For example, from the description “preferably from 10 to 90, more preferably from 30 to 60”, the “preferred lower limit (10)” and the “preferred upper limit (60)” can be combined as “from 10 to 60”.

In the present specification, “energy beam” refers to an electromagnetic wave or a charged particle beam having an energy quantum, and examples include ultraviolet light, radiation, and electron beams. Ultraviolet light can be applied, for example, using an electrodeless lamp, a high-pressure mercury lamp, a metal halide lamp, a UV-LED, or the like as an ultraviolet light source. The electron beam can be generated by an electron beam accelerator or the like and irradiated. Among the energy beams described above, the energy beam in an aspect of the present invention is preferably ultraviolet light.

In the present specification, “energy-beam-crosslinkable” refers to a property of forming a crosslinked structure when irradiated with energy beams.

A mechanism of action described in the present specification is speculative and is not intended to limit the mechanism by which the effects of the present invention are achieved.

Energy-Beam-Crosslinkable Pressure Sensitive Adhesive Composition and Crosslinked Pressure Sensitive Adhesive

An energy-beam-crosslinkable pressure sensitive adhesive composition of the present embodiment is an energy-beam-crosslinkable pressure sensitive adhesive composition containing:
an acrylic resin (A) having energy beam crosslinkability, and;
a tackifier (B), in which
the tackifier (B) contains a styrene-based resin (B1).

In addition, a crosslinked pressure sensitive adhesive of the present embodiment is a crosslinked pressure sensitive adhesive obtained by irradiating the energy-beam-crosslinkable pressure sensitive adhesive composition of the present embodiment with an energy beam.

The crosslinked pressure sensitive adhesive obtained by irradiating the energy-beam-crosslinkable pressure sensitive adhesive composition of the present embodiment with an energy beam has good peel strength and excellent holding power. The reason for that is presumed as follows.

The energy-beam-crosslinkable pressure sensitive adhesive composition of the present embodiment contains an acrylic resin (A) having energy beam crosslinkability (hereinafter, also referred to as the “energy-beam-crosslinkable acrylic resin (A)” or the “component (A)”).

The energy-beam-crosslinkable acrylic resin (A) can be applied in a melted state and, after application, irradiation with an energy beam causes a crosslinking reaction that improves the cohesive strength thereof. On the other hand, the energy-beam-crosslinkable acrylic resin (A) alone has a high peel strength to a high-polarity adherend, such as stainless steel, but does not have a sufficient peel strength to a low-polarity adherend, such as polyolefin.

A technique for improving the peel strength to a low-polarity adherend has been proposed, in which a tackifier is added to an acrylic pressure sensitive adhesive, but the combined use with the energy-beam-crosslinkable acrylic resin (A) may reduce the holding power of the pressure sensitive adhesive.

As a result of studying the tackifier used together with the energy-beam-crosslinkable acrylic resin (A), the present inventors have found that use of the styrene-based resin (B1) greatly improves the holding power of the pressure sensitive adhesive while providing good peel strength.

One of the reasons for this may be that the styrene-based resin (B1) contains fewer unsaturated double bonds, which inhibit the radical reaction of the component (A), than other tackifiers, such as rosin-based or terpene-phenolic tackifiers. This is presumed to have allowed the energy beam crosslinking reaction of the component (A) to proceed sufficiently and improve the cohesive strength and holding power of the pressure sensitive adhesive.

Hereinafter, the energy-beam-crosslinkable pressure sensitive adhesive composition of the present embodiment (hereinafter also referred to simply as the “pressure sensitive adhesive composition”) and the crosslinked pressure sensitive adhesive will be described in more detail.

### Energy-Beam-Crosslinkable Pressure Sensitive Adhesive Composition

As described above, the pressure sensitive adhesive composition of the present embodiment forms a crosslinked pressure sensitive adhesive with excellent holding power by forming a crosslinked structure by irradiation with an energy beam. That is, the pressure sensitive adhesive composition of the present embodiment is a composition intended to be irradiated with an energy beam before or after being applied to an adherend.

The pressure sensitive adhesive composition of the present embodiment can be irradiated with an energy beam at any time. Thus, the pressure sensitive adhesive composition of the present embodiment has a high degree of freedom in its production method and use method.

Specifically, the pressure sensitive adhesive composition of the present embodiment has no intentional crosslinked structure formed in it and thus can be heat-melted and is suitable as a hot-melt pressure sensitive adhesive.

Furthermore, the pressure sensitive adhesive composition of the present embodiment has no intentional crosslinked structure formed in it and thus has excellent shape conformability. Thus, both shape conformability and holding power can be achieved by applying the pressure sensitive adhesive composition of the present embodiment to an adherend with a step or the like and then forming a crosslinked pressure sensitive adhesive by energy beam irradiation.

Next, each component contained in the pressure sensitive adhesive composition of the present embodiment will be described in detail.

### Energy-Beam-Crosslinkable Acrylic Resin (A)

The energy-beam-crosslinkable acrylic resin (A) is any acrylic resin having energy beam crosslinkability and is not particularly limited.

One type of energy-beam-crosslinkable acrylic resin (A) may be used alone, or two or more types may be used in combination.

Examples of the energy-beam-crosslinkable acrylic resin (A) include an acrylic resin having an energy-beam-reactive group that reacts by energy beam irradiation and contributes to formation of a crosslinked structure.

Examples of the energy-beam-reactive group include a group that is excited by irradiation with an energy beam and generates a radical that triggers a crosslinking reaction.

Specific examples of the energy-beam-reactive group include functional groups having a structure, such as a benzophenone structure, a benzyl structure, an o-benzoylbenzoic ester structure, a thioxanthone structure, a 3-ketocoumarin structure, a 2-ethylanthraquinone structure, and a camphorquinone structure. Among these, the energy-beam-crosslinkable acrylic resin (A) preferably has a benzophenone structure in a side chain.

In the energy-beam-crosslinkable acrylic resin (A) having a benzophenone structure, for example, the benzophenone structure draws a hydrogen atom from a hydrocarbon group contained in a side chain of the acrylic resin by energy beam irradiation, the radicals are recombined, and a crosslinked structure is formed.

The energy-beam-reactive group is preferably introduced into a side chain of the acrylic resin from the viewpoint of facilitating the formation of the crosslinked structure. That is, the energy-beam-crosslinkable acrylic resin (A) is preferably an acrylic resin having a benzophenone structure in a side chain.

The content of the energy-beam-reactive group in the energy-beam-crosslinkable acrylic resin (A) is preferably from 0.1 to 5.0 mass % and more preferably from 0.2 to 3.0 mass % relative to a total amount (100 mass %) of the energy-beam-crosslinkable acrylic resin (A).

The acrylic resin is any polymer containing an acrylic monomer as a monomer component and is not particularly limited but preferably contains a constituent unit derived from an alkyl (meth)acrylate.

Examples of the alkyl (meth)acrylate include methyl (meth)acrylate, ethyl (meth)acrylate, n-propyl (meth)acrylate, n-butyl (meth)acrylate, isobutyl (meth)acrylate, sec-butyl (meth)acrylate, n-hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, and lauryl (meth)acrylate. Among these, the alkyl (meth)acrylate is preferably an alkyl (meth)acrylate in which the alkyl group has one or more and eight or less carbons, and is more preferably 2-ethylhexyl (meth)acrylate, methyl (meth)acrylate, or butyl (meth)acrylate.

The content of the energy-beam-crosslinkable acrylic resin (A) in the pressure sensitive adhesive composition of the present embodiment may be from 20 to 95 mass %, from 40 to 90 mass %, or from 60 to 80 mass % relative to a total amount (100 mass %) of the pressure sensitive adhesive composition.

### Tackifier (B)

The pressure sensitive adhesive composition of the present embodiment further contains the tackifier (B).

The tackifier (B) is a component that improves the pressure sensitive adhesive properties of the resulting crosslinked pressure sensitive adhesive, and in the pressure sensitive adhesive composition of the present embodiment, the tackifier (B) contains the styrene-based resin (B1).

One type of tackifier (B) may be used alone, or two or more types may be used in combination.

### Styrene-Based Resin (B1)

The styrene-based resin (B1) is any polymer containing a styrene-based monomer as a monomer component and is not particularly limited.

Examples of the styrene-based monomer include styrene, α-methylstyrene, o-methylstyrene, m-methylstyrene, p-methylstyrene, p-t-butylstyrene, 1,3-dimethylstyrene, and 2,4-dimethylstyrene.

Examples of the styrene-based resin (B1) include homopolymers of styrene-based monomers, copolymers of styrene-based monomers and aliphatic hydrocarbon-based monomers, and copolymers of styrene-based monomers and aromatic hydrocarbon-based monomers. Among these, a homopolymer of styrene-based monomers is preferred.

The content of the styrene-based resin (B1) in the pressure sensitive adhesive composition of the present embodiment is preferably from 1 to 40 parts by mass, more preferably from 5 to 35 parts by mass, and even more preferably from 10 to 30 parts by mass per 100 parts by mass of the energy-beam-crosslinkable acrylic resin (A).

With a content of 1 part by mass or more, the styrene-based resin (B1) tends to facilitate further improvement of the peel strength. In addition, with a content of the styrene-based resin (B1) of 40 parts by mass or less, the pressure sensitive adhesive has excellent transparency.

### Hydrogenated Terpene Phenolic Resin (B2) and Hydrogenated Rosin-Based Resin (B3)

The pressure sensitive adhesive composition of the present embodiment preferably contains, together with the styrene-based resin (B1), one or more selected from the group consisting of a hydrogenated terpene phenolic resin (B2) and a hydrogenated rosin-based resin (B3).

A styrene-based resin (B1) tends to have high transparency, but mixing it with the energy-beam-crosslinkable acrylic resin (A) tends to cause haze to some extent because of a difference in the SP values of the two. In contrast to this, in the pressure sensitive adhesive composition containing the hydrogenated terpene phenolic resin (B2) and the hydrogenated rosin-based resin (B3), these tackifiers function as compatibilizing components that improve the compatibility between the energy-beam-crosslinkable acrylic resin (A) and the styrene-based resin (B1) and tend to be able to improve the transparency of the pressure sensitive adhesive composition and the crosslinked pressure sensitive adhesive obtained from the pressure sensitive adhesive composition.

The hydrogenated terpene phenolic resin (B2) is a resin obtained by hydrogenation of terpene-derived double bonds and phenol-derived aromatic ring double bonds contained in a terpene phenolic resin.

The terpene phenolic resin to be subjected to hydrogenation is a resin containing at least a terpene-derived structure and a phenolic compound-derived structure, and may be a copolymer of a terpene and a phenolic compound or may be a resin obtained by polymerization of terpene and modification of the resulting terpene resin with a phenolic compound. Among these, the terpene phenolic resin is preferably a copolymer of a terpene and a phenolic compound.

The terpene as a raw material is not particularly limited, and examples include α-pinene, β-pinene, and limonene.

The hydrogenated terpene phenolic resin (B2) may be a partially hydrogenated terpene phenolic resin obtained by partial hydrogenation of a terpene phenolic resin but is preferably a completely hydrogenated terpene phenolic resin obtained by substantially complete hydrogenation of a terpene phenolic resin from the viewpoint of not inhibiting the radical reaction of the energy-beam-crosslinkable acrylic resin (A) and from the viewpoint of facilitating further improvement of the transparency.

The hydrogenated rosin-based resin (B3) is a resin obtained by hydrogenation of double bonds contained in rosin or in a rosin-derived resin, and examples include hydrogenated rosins and hydrogenated rosin ester-based resins.

In the present specification, “hydrogenated rosin” refers to a rosin obtained by adding hydrogen to a purified rosin containing abietic acid as a main component in the presence of a catalyst. In addition, the “hydrogenated rosin ester-based resin” refers to a resin obtained by esterification of a hydrogenated rosin with an alcohol, such as glycerin or pentaerythritol.

The hydrogenated rosin-based resin (B3) may be a partially hydrogenated rosin-based resin obtained by partial hydrogenation of rosin or a rosin-derived resin but is preferably a completely hydrogenated rosin-based resin obtained by substantially complete hydrogenation of rosin or a rosin-derived resin from the viewpoint of not inhibiting the radical reaction of the energy-beam-crosslinkable acrylic resin (A) and from the viewpoint of facilitating further improvement of the transparency.

In the pressure sensitive adhesive composition of the present embodiment containing one or more selected from the group consisting of a hydrogenated terpene phenolic resin (B2) and a hydrogenated rosin-based resin (B3), their content is preferably from 1 to 39 parts by mass, more preferably from 3 to 35 parts by mass, and even more preferably from 5 to 30 parts by mass per 100 parts by mass of the energy-beam-crosslinkable acrylic resin (A).

With a content of 1 part by mass or more, the one or more selected from the group consisting of the hydrogenated terpene phenolic resin (B2) and the hydrogenated rosin-based resin (B3) tend to facilitate further improvement of the transparency and the peel strength. In addition, with a content of 39 parts by mass or less, the one or more selected from the group consisting of the hydrogenated terpene phenolic resin (B2) and the hydrogenated rosin-based resin (B3) tend to facilitate further improvement of the holding power.

### Softening Point of Tackifier (B)

The softening point of the tackifier (B) is preferably from 70 to 140° C., more preferably from 80 to 130° C., and even more preferably from 85 to 120° C.

With a softening point of 70° C. or higher, the tackifier (B) tends to make it easier to obtain excellent peel strength at high temperatures. In addition, with a softening point of 140° C. or lower, the tackifier (B) tends to easily mix with the energy-beam-crosslinkable acrylic resin (A).

In the present specification, the softening point of the tackifier (B) refers to a value measured in accordance with JIS K 5601-2-2.

The total content of the tackifier (B) in the pressure sensitive adhesive composition of the present embodiment is preferably from 5 to 40 parts by mass, more preferably from 10 to 40 parts by mass, and even more preferably from 20 to 40 parts by mass per 100 parts by mass of the energy-beam-crosslinkable acrylic resin (A).

With a total content of 5 parts by mass or more, the tackifier (B) tends to facilitate further improvement of the peel strength. In addition, with a content of 40 parts by mass or less, the tackifier (B) tends to facilitate further improvement of the holding power.

The pressure sensitive adhesive composition of the present embodiment may contain an additional tackifier other than the styrene-based resin (B1), the hydrogenated terpene phenolic resin (B2), and the hydrogenated rosin-based resin (B3). However, from the viewpoint of not inhibiting the radical reaction of the energy-beam-crosslinkable acrylic resin (A) and from the viewpoint of facilitating further improvement of the transparency, the pressure sensitive adhesive composition preferably does not contain the additional tackifier.

Total content of the styrene-based resin (B1), the hydrogenated terpene phenolic resin (B2), and the hydrogenated rosin-based resin (B3) in the tackifier (B) contained in the pressure sensitive adhesive composition of the present embodiment is preferably from 90 to 100 mass %, more preferably from 95 to 100 mass %, and even more preferably from 98 to 100 mass % relative to a total amount (100 mass %) of the tackifier (B) from the same viewpoints as described above.

### Additional Component

The pressure sensitive adhesive composition of the present embodiment may or may not contain an additional component other than components described above.

Examples of the additional component include softening agents: antioxidants; and additives used in a common pressure sensitive adhesive.

One of these additional components may be used alone, or two or more may be used in combination.

The antioxidant is not particularly limited, and an antioxidant known in the art can be used. Examples include hindered phenolic antioxidants, such as 2,6-di-tert-butyl-4-(4,6-bis(octylthio)-1,3,5-triazin-2-ylamino)phenol, 2,6-di-t-butyl-4-methylphenol, n-octadecyl-3-(4′-hydroxy-3′,5′-di-t-butylphenyl) propionate, 2,2′-methylene bis(4-methyl-6-t-butylphenol), 2,2′-methylene bis(4-ethyl-6-t-butylphenol), 2,4-bis(octylthiomethyl)-o-cresol, 2-t-butyl-6-(3-t-butyl-2-hydroxy-5-methylbenzyl)-4-methylphenyl acrylate, 2,4-di-t-amyl-6-[1-(3,5-di-t-amyl-2-hydroxyphenyl)ethyl]phenyl acrylate, 2-[1-(2-hydroxy-3,5-di-tert-pentylphenyl)] acrylate, and tetrakis[methylene-3-(3,5-di-t-butyl-4-hydroxyphenyl) propionate] methane: sulfur-based antioxidants, such as dilauryl thiodipropionate, lauryl stearyl thiodipropionate, and pentaerythritol tetrakis(3-lauryl thiopropionate): and phosphorus-based antioxidants, such as tris(nonylphenyl) phosphite and tris(2,4-di-t-butylphenyl) phosphite.

Examples of the additive for a pressure sensitive adhesive used in a common pressure sensitive adhesive include waxes, fillers, extenders, thermal stabilizers, light stabilizers, ultraviolet absorbers, colorants (such as pigments and dyes), flame retardants, antistatic agents, stringiness retarders, leveling agents, crosslinking agents, crosslinking aids, antioxidants (anti-aging agents), inorganic particles, organic particles, and weight-reducing agents.

Each of these additives for a pressure sensitive adhesive may be used individually, or two or more from each may be used in combination.

In the pressure sensitive adhesive composition containing an additive for a pressure sensitive adhesive of these, the content of the additive for a pressure sensitive adhesive is each independently preferably from 0.0001 to 20 parts by mass and more preferably from 0.001 to 10 parts by mass per 100 parts by mass of the energy-beam-crosslinkable acrylic resin (A).

### Method for Producing Pressure Sensitive Adhesive Composition

The pressure sensitive adhesive composition of the present embodiment can be produced, for example, by a method in which the energy-beam-crosslinkable acrylic resin (A), the tackifier (B), and an optional component used as necessary are melt-kneaded.

In the following description, the step of melt-kneading the components, such as the energy-beam-crosslinkable acrylic resin (A) and the tackifier (B), may be referred to as the “melt-kneading step”.

The melt-kneading step is, for example, a step of placing the components into a mixing device equipped with a heating device, such as a heating kneader, and mixing components in a melted state.

Examples of the mixing device equipped with a heating device include a single-screw extruder, a twin-screw extruder, a roll mill, a Plastomill, a Banbury mixer, an Intermix, and a pressure kneader.

When a mixing device capable of reducing pressure is used, the pressure inside the mixing device may be reduced as necessary to perform melt-kneading under reduced pressure.

The kneading temperature in the melt-kneading step is not particularly limited, and a temperature condition under which the components are sufficiently mixed in a melted state is to be appropriately selected. The kneading temperature is preferably from 80 to 180ºC, more preferably from 100 to 170° C., and even more preferably from 120 to 150° C.

When the pressure sensitive adhesive composition of the present embodiment is produced by melt-kneading, the pressure sensitive adhesive composition of the present embodiment does not need to contain a solvent and preferably does not contain a solvent from the viewpoint of reducing the environmental load. In the pressure sensitive adhesive composition containing a solvent, the content of the solvent is preferably 10 mass % or less, more preferably 5 mass % or less, and even more preferably 1 mass % or less relative to a total amount (100 mass %) of the pressure sensitive adhesive composition of the present embodiment.

The pressure sensitive adhesive composition obtained after completion of the melt-kneading may be applied as is in a heat-melted state on a substrate or a release liner with an extruder or the like and subjected to a production of a pressure sensitive adhesive sheet of the present embodiment described later, or may be, for example, filled into a container of any of various types or the like without going through a forming step if desired.

### Crosslinked Pressure Sensitive Adhesive

The crosslinked pressure sensitive adhesive of the present embodiment is a crosslinked pressure sensitive adhesive obtained by irradiating the energy-beam-crosslinkable pressure sensitive adhesive composition of the present embodiment with an energy beam.

That is, the crosslinked pressure sensitive adhesive of the present embodiment has a crosslinked structure formed by an energy beam crosslinking reaction of the energy-beam-crosslinkable acrylic resin (A) contained in the energy-beam-crosslinkable pressure sensitive adhesive composition of the present embodiment.

The crosslinked pressure sensitive adhesive itself of the present embodiment also has good peel strength and exhibits excellent adhesive strength to an adherend. Thus, from the viewpoint of eliminating the need for the energy beam irradiation step after the pressure sensitive adhesive composition is applied to an adherend, an aspect is preferred, in which before the pressure sensitive adhesive composition is applied to an adherend, the crosslinked pressure sensitive adhesive of the present embodiment is formed by irradiating the pressure sensitive adhesive composition with an energy beam, and the crosslinked pressure sensitive adhesive is applied to an adherend as the crosslinked pressure sensitive adhesive.

The peel strength of the crosslinked pressure sensitive adhesive of the present embodiment to a polyethylene plate at 23° C. is preferably 3 N/25 mm or more, more preferably 5 N/25 mm or more, and even more preferably 6 N/25 mm or more.

With a peel strength of 3 N/25 mm or more, the crosslinked pressure sensitive adhesive tends to be less likely to lift, peel off, and/or the like from the adherend.

The upper limit of the peel strength of the crosslinked pressure sensitive adhesive to a polyethylene plate at 23° C. is not particularly limited but may be 50 N/25 mm or less or 30 N/25 mm or less from the viewpoint of maintaining a good balance between ease of production and other performances.

The peel strength of the crosslinked pressure sensitive adhesive to a polyethylene plate at 23° C. can be measured by a method described in Examples.

The gel fraction of the crosslinked pressure sensitive adhesive of the present embodiment is preferably from 30 to 85 mass %, more preferably from 35 to 80 mass %, and even more preferably from 40 to 75 mass %.

With a gel fraction of 30 mass % or more, the crosslinked pressure sensitive adhesive tends to facilitate further improvement of the holding power. In addition, with a gel fraction of 85 mass % or less, the crosslinked pressure sensitive adhesive tends to facilitate further improvement of the peel strength.

In the present embodiment, the gel fraction of the crosslinked pressure sensitive adhesive can be measured by a method described in Examples.

The haze of the crosslinked pressure sensitive adhesive of the present embodiment is preferably 15% or less, more preferably 8% or less, and even more preferably 4% or less.

With a haze of the crosslinked pressure sensitive adhesive of 15% or less, the crosslinked pressure sensitive adhesive of the present embodiment tends to be suitable for applications requiring transparency.

In the present embodiment, the haze of the crosslinked pressure sensitive adhesive can be measured by a method described in Examples.

The crosslinked pressure sensitive adhesive of the present embodiment can be produced by a method in which the energy-beam-crosslinkable pressure sensitive adhesive composition of the present embodiment is irradiated with an energy beam.

In the following descriptions, the step of irradiating the energy-beam-crosslinkable pressure sensitive adhesive composition of the present embodiment with an energy beam may be referred to as the “energy beam irradiation step”.

### Pressure Sensitive Adhesive Sheet

The present invention provides a first pressure sensitive adhesive sheet and a second pressure sensitive adhesive sheet described below.

The first pressure sensitive adhesive sheet is a pressure sensitive adhesive sheet having an energy-beam-crosslinkable pressure sensitive adhesive composition layer composed of the energy-beam-crosslinkable pressure sensitive adhesive composition of the present embodiment on a substrate or a release liner.

The second pressure sensitive adhesive sheet is a pressure sensitive adhesive sheet having a pressure sensitive adhesive layer composed of the crosslinked pressure sensitive adhesive of the present embodiment on a substrate or a release liner.

In the following descriptions, “the pressure sensitive adhesive sheet” refers to both the first pressure sensitive adhesive sheet and the second pressure sensitive adhesive sheet.

Next, an example of the configuration of the pressure sensitive adhesive sheet of the present embodiment will be described using drawings, but the pressure sensitive adhesive sheet of the present embodiment is not limited to the following examples as long as the effects of the present embodiment are exerted.

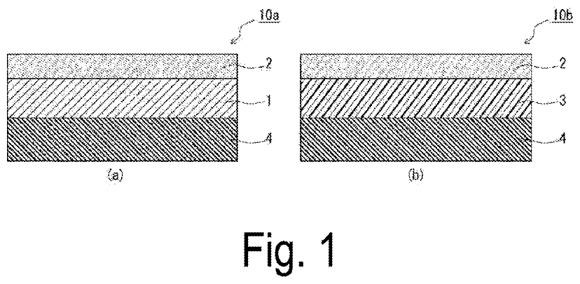

FIG. 1(a) illustrates, as an example of the first pressure sensitive adhesive sheet, a pressure sensitive adhesive sheet 10a having: a release liner 2 on one surface side of a pressure sensitive adhesive composition layer 1; and a substrate 4 on the other surface side of the pressure sensitive adhesive composition layer 1.

In addition, FIG. 1(b) illustrates, as an example of the second pressure sensitive adhesive sheet, a pressure sensitive adhesive sheet 10b having: the release liner 2 on one surface side of a pressure sensitive adhesive layer 3; and the substrate 4 on the other surface side of the pressure sensitive adhesive layer 3.

The pressure sensitive adhesive sheets 10a and 10b are suitable for applications in which, for example, the release liner 2 is peeled off and removed and then the exposed surface of the pressure sensitive adhesive composition layer 1 or the pressure sensitive adhesive layer 3 is applied to an adherend. Examples of such applications include label applications.

In the case where the pressure sensitive adhesive sheet to be applied to an adherend is the first pressure sensitive adhesive sheet, the pressure sensitive adhesive composition layer is applied to an adherend and then irradiated with an energy beam to form a pressure sensitive adhesive layer.

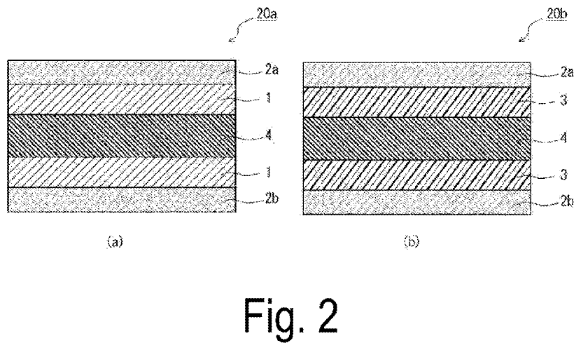

FIG. 2(a) illustrates, as another example of the first pressure sensitive adhesive sheet, a double-sided pressure sensitive adhesive sheet 20a having: pressure sensitive adhesive composition layers 1 on both surfaces of the substrate 4: a release liner 2a on a surface of one pressure sensitive adhesive composition layer 1, the surface being on the opposite side to the substrate 4; and a release liner 2b on a surface of the other pressure sensitive adhesive composition layer 1, the surface being on the opposite side to the substrate 4.

In addition, FIG. 2(b) illustrates, as another example of the second pressure sensitive adhesive sheet, a double-sided pressure sensitive adhesive sheet 20b having: the pressure sensitive adhesive layers 3 on both surfaces of the substrate 4; the release liner 2a on a surface of one pressure sensitive adhesive layer 3, the surface being on the opposite side to the substrate 4; and the release liner 2b on a surface of the other pressure sensitive adhesive layer 3, the surface being on the opposite side to the substrate 4.

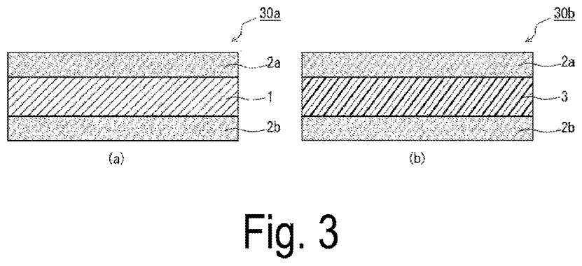

FIG. 3(a) illustrates, as another example of the first pressure sensitive adhesive sheet, a substrate-less pressure sensitive adhesive sheet 30a having the release liners 2a and 2b on both sides of the pressure sensitive adhesive composition layer 1.

FIG. 3(b) illustrates, as another example of the second pressure sensitive adhesive sheet, a substrate-less pressure sensitive adhesive sheet 30b having the release liners 2a and 2b on both surfaces of the pressure sensitive adhesive layer 3.

The pressure sensitive adhesive sheets 20a, 20b, 30a, and 30b are suitable for bonding adherends together, in which, for example, the release liner 2a on one surface side is peeled off and removed, then the exposed surface of the pressure sensitive adhesive composition layer 1 or the pressure sensitive adhesive layer 3 is applied to an adherend, then the release liner 2b is further peeled off and removed, and then the exposed surface of the pressure sensitive adhesive composition layer 1 or the pressure sensitive adhesive layer 3 is applied to another adherend. Examples of such applications include applications for fixing or temporarily fixing various components.

In the pressure sensitive adhesive sheets 30a and 30b, in the case where the peeling force for peeling off the release liner 2a from the pressure sensitive adhesive composition layer 1 or the pressure sensitive adhesive layer 3 is approximately the same as the peeling force for peeling off the release liner 2b from the pressure sensitive adhesive composition layer 1 or the pressure sensitive adhesive layer 3, an attempt to peel off both release liners by pulling them outward may result in a phenomenon where the pressure sensitive adhesive composition layer 1 or the pressure sensitive adhesive layer 3 is divided along with the two release liners and peeled off. From the viewpoint of suppressing such a phenomenon, two release liners designed to have different peeling forces are preferably used as the two release liners 2a and 2b.

The thickness of the pressure sensitive adhesive composition layer in the first pressure sensitive adhesive sheet and the thickness of the pressure sensitive adhesive layer in the second pressure sensitive adhesive sheet are preferably from 5 to 100 μm, more preferably from 10 to 60 μm, and even more preferably from 15 to 30 μm.

With a thickness of 5 μm or greater, the pressure sensitive adhesive composition layer and the pressure sensitive adhesive layer tend to facilitate further improvement of the peel strength. In addition, with a thickness of 100 μm or less, the pressure sensitive adhesive composition layer and the pressure sensitive adhesive layer tend to facilitate further improvement of the handling properties.

### Substrate

Examples of a material forming the substrate include resins, metals, and paper materials.

Examples of the resin include: polyolefin resins, such as polyethylene and polypropylene: vinyl-based resins, such as poly(vinyl chloride), poly(vinylidene chloride), poly(vinyl alcohol), ethylene-vinyl acetate copolymers, and ethylene-vinyl alcohol copolymers: polyester-based resins, such as poly(ethylene terephthalate), poly(butylene terephthalate), and poly(ethylene naphthalate); polystyrene; acrylonitrile-butadiene-styrene copolymers; cellulose triacetate; polycarbonate; urethane resins, such as polyurethane and acrylic-modified polyurethane; polymethylpentene; polysulfone; polyetheretherketone; polyethersulfone; poly(phenylene sulfide); polyimide-based resins, such as polyetherimide and polyimide; polyamide-based resins; acrylic resins; and fluorine-based resins.

Examples of the metal include aluminum, tin, chromium, and titanium.

Examples of the paper material include tissue paper, wood-containing paper, wood-free paper, impregnated paper, coat paper, art paper, vegetable parchment, and glassine paper.

The material forming the substrate may be composed of one material, or two or more of the materials may be used in combination.

Examples of the substrate obtained using two or more forming materials in combination include: a substrate obtained by laminating a paper material with a thermoplastic resin, such as polyethylene; and a substrate obtained by forming a metal film on the surface of a resin film or sheet containing a resin. Examples of the method for forming the metal layer include a method in which the metal is vapor-deposited by a PVD method, such as vacuum deposition, sputtering, or ion plating: or a method in which a metal foil made of the metal is applied using a common pressure sensitive adhesive.

From the viewpoint of improving interlayer adhesion between the substrate and another layer to be laminated, for the substrate containing a resin, the surface of the substrate may be subjected to surface treatment by a method, such as oxidation or roughening: adhesive treatment: or primer treatment.

According to the application of the pressure sensitive adhesive sheet, the substrate may have, for example, a primer layer for facilitating printing: a recording layer for enabling recording, such as thermal transfer recording and ink-jet recording: an overcoat film or an overlaminate film for protecting these surfaces; and/or an information region, such as a magnetic recording, a bar code, or a micro semiconductor device.

On the other hand, when the pressure sensitive adhesive sheet of the present embodiment is formed as a transparent pressure sensitive adhesive sheet with transparency, the substrate preferably has transparency. The crosslinked pressure sensitive adhesive of the present embodiment can be designed to have high transparency and thus is suitable for producing a transparent pressure sensitive adhesive sheet in combination with a substrate with transparency.

The substrate may contain an additive for a substrate as necessary. Examples of the additive for a substrate include ultraviolet absorbers, light stabilizers, antioxidants, antistatic agents, slip agents, antiblocking agents, and colorants. These additives for a substrate may each be used alone, or two or more may be used in combination.

The thickness of the substrate is preferably from 5 to 1000 μm, more preferably from 15 to 500 μm, and even more preferably from 20 to 200 μm.

With a thickness of 5 μm or greater, the substrate tends to facilitate the improvement of the deformation resistance of the pressure sensitive adhesive sheet. On the other hand, with a thickness of 1000 μm or less, the substrate tends to facilitate the improvement of the handling properties of the pressure sensitive adhesive sheet.

The “thickness of the substrate” refers to the thickness of the entire substrate; for a substrate composed of a plurality of layers, the thickness refers to the total thickness of all layers composing the substrate.

### Release Liner

For the release liner, a release liner subjected to double-sided release treatment, a release liner subjected to single-sided release treatment, or the like is used. Examples include a release liner obtained by applying a release agent on a substrate for a release liner.

Examples of the substrate for a release liner include paper, such as wood-free paper, glassine paper, and kraft paper; and plastic films, such as polyester resin films of a poly(ethylene terephthalate) resin, a poly(butylene terephthalate) resin, a poly(ethylene naphthalate) resin, or the like, and polyolefin resin films of a polypropylene resin, a polyethylene resin, or the like.

Examples of the release agent include rubber-based elastomers, such as silicone-based resins, olefin-based resins, isoprene-based resins, and butadiene-based resins; long-chain alkyl-based resins: alkyd-based resins; and fluorine-based resins.

The thickness of the release liner is not particularly limited as long as the effects of the present invention are not impaired, but the thickness is preferably from 10 to 200 μm, more preferably from 20 to 180 μm, and even more preferably from 30 to 150 μm.

### Method for Producing First Pressure Sensitive Adhesive Sheet

A method for producing the first pressure sensitive adhesive sheet is a method, in which the energy-beam-crosslinkable pressure sensitive adhesive composition of the present embodiment is obtained by melt-kneading the energy-beam-crosslinkable acrylic resin (A) and the tackifier (B), and the energy-beam-crosslinkable pressure sensitive adhesive composition layer is formed by applying the energy-beam-crosslinkable pressure sensitive adhesive composition in a melted state on the substrate or the release liner.

In the following descriptions, the step of forming the energy-beam-crosslinkable pressure sensitive adhesive composition layer by applying the energy-beam-crosslinkable pressure sensitive adhesive composition in a melted state on the substrate or the release liner may be referred to as the “pressure sensitive adhesive composition layer-forming step”.

In addition, in the present embodiment, “on the release liner” refers to “on the release-treated surface” for a release liner subjected to single-sided release treatment.

In the method for producing the first pressure sensitive adhesive sheet, the description of the step of melt-kneading the energy-beam-crosslinkable acrylic resin (A) and the tackifier (B) is the same as the description of the melt-kneading step in the method for producing the pressure sensitive adhesive composition of the present embodiment.

The pressure sensitive adhesive composition layer-forming step may be a method in which the pressure sensitive adhesive composition obtained after completion of melt-kneading is applied as is in a heat-melted state on a substrate or a release liner using an extruder, a T-die, and the like to form a layer. Thereafter, the method may have as necessary a step of cooling the pressure sensitive adhesive composition layer.

The pressure sensitive adhesive composition layer can be formed on the substrate or the release liner by the above pressure sensitive adhesive composition layer-forming step.

The sheet with the substrate or the release liner and the pressure sensitive adhesive composition layer may be used as it is as the first pressure sensitive adhesive sheet of the present embodiment or may be subjected to an additional step as necessary to configure a desired pressure sensitive adhesive sheet.

For example, a pressure sensitive adhesive sheet having a release liner on one surface side of a pressure sensitive adhesive composition layer and having a substrate on the other surface side of the pressure sensitive adhesive composition layer as in the pressure sensitive adhesive sheet 10a illustrated in FIG. 1(a) can be produced by applying the release-treated surface of the release liner to the exposed surface of the pressure sensitive adhesive composition layer formed on the substrate.

In addition, a double-sided pressure sensitive adhesive sheet having pressure sensitive adhesive composition layers on both surfaces of a substrate and having a release liner on the surface of each pressure sensitive adhesive composition layer, the surface being on the opposite side to the substrate, as in the pressure sensitive adhesive sheet 20a illustrated in FIG. 2(a) can be produced by applying the substrate surface of the pressure sensitive adhesive sheet 10a to the exposed surface of the pressure sensitive adhesive composition layer formed on the release liner.

Alternatively, a substrate-less pressure sensitive adhesive sheet having release liners on both surfaces of the pressure sensitive adhesive composition layer as in the pressure sensitive adhesive sheet 30a illustrated in FIG. 3(a) can be produced by applying the release-treated surface of one release liner to the exposed surface of the pressure sensitive adhesive composition layer formed on another release liner.

### Method for Producing Second Pressure Sensitive Adhesive Sheet

A method for producing the second pressure sensitive adhesive sheet is a method for producing a pressure sensitive adhesive sheet, the method including: forming an energy-beam-crosslinkable pressure sensitive adhesive composition layer composed of the energy-beam-crosslinkable pressure sensitive adhesive composition on the substrate or the release liner: and irradiating the energy-beam-crosslinkable pressure sensitive adhesive composition layer with an energy beam.

In the method for producing the second pressure sensitive adhesive sheet, the description of the step of forming an energy-beam-crosslinkable pressure sensitive adhesive composition layer is the same as the description of the step of forming a pressure sensitive adhesive composition layer in the method for producing the first pressure sensitive adhesive sheet.

In the method for producing the second pressure sensitive adhesive sheet, the timing at which the energy beam irradiation is performed is not particularly limited and is to be appropriately determined in consideration of the method for producing the pressure sensitive adhesive sheet, desired physical properties, and the like.

For example, in a state where one surface of the pressure sensitive adhesive composition layer is exposed, the pressure sensitive adhesive composition layer may be irradiated with an energy beam directly or through the substrate or the release liner, or in a state where the pressure sensitive adhesive composition layer has the substrate or the release liner on one surface and the release liner on the other surface, the pressure sensitive adhesive composition layer may be irradiated with an energy beam through the substrate or the release liner.

In addition, the energy beam irradiation may be performed once or may be performed multiple times. When the energy beam irradiation is performed multiple times, for example, the first energy beam irradiation may be performed in a state where one surface of the pressure sensitive adhesive composition layer is exposed, then the substrate or the release liner is applied to the surface, and then the second energy beam irradiation may be performed through the substrate or the release liner.

Alternatively, the first energy beam irradiation may be performed at any time before the application to the adherend, and the second energy beam irradiation may be performed after the application to the adherend.

Applications of energy-beam-crosslinkable pressure sensitive adhesive composition, crosslinked pressure sensitive adhesive, and pressure sensitive adhesive sheet

The energy-beam-crosslinkable pressure sensitive adhesive composition, the crosslinked pressure sensitive adhesive, and the pressure sensitive adhesive sheet of the present embodiment can be used in various applications.

Specific examples include label applications: applications for fixing or temporarily fixing various components: surface protection applications: sealing material applications: and decoration and display applications.

Among these, label applications and applications for fixing or temporarily fixing various components are preferred.

The pressure sensitive adhesive sheet for label applications may be directly adhered to various products or may be adhered to packaging films and packaging containers of various products, and the like. Examples of the constituent material of the packaging film and the packaging container include olefin-based resins, such as polypropylene and polyethylene: polyester-based resins, such as poly (ethylene terephthalate) (PET) and poly(lactic acid): glass, paper, and metal.

Among these, the pressure sensitive adhesive sheet of the present embodiment exhibits high peel strength to olefin-based resins and thus is suitable for a use aspect in which the pressure sensitive adhesive sheet is applied to a packaging film, a packaging container, or the like made of an olefin-based resin, such as polypropylene or polyethylene.

The pressure sensitive adhesive sheet for applications for fixing or temporary fixing is suitable for fixing or temporarily fixing, for example, electronic members, optical members, automobile components, mechanism components, construction members, or decorative members.

### EXAMPLES

The present invention will be specifically described with reference to examples below, but the present invention is not limited to the following examples. Physical property values in each example are values measured by the following methods.

### Thickness of Each Layer

The thickness of each layer was measured at 23° C. using a constant-pressure thickness meter (model number “PG-02J”, standard specifications in accordance with JIS K 6783, Z 1702, and Z 1709).

Details of materials used in the following examples and comparative examples are as shown below.

### Component (A)

Energy-beam-crosslinkable acrylic resin: acrylic resin having a benzophenone structure in a side chain, available from BASF, trade name “acResin A204UV”

### Component (B)

Styrene-based resin (B1): homopolymer of styrene-based monomers, available from Yasuhara Chemical Co., Ltd., trade name “SX100”, softening point of 100° C.
Hydrogenated terpene phenolic resin (B2): available from Yasuhara Chemical Co., Ltd., trade name “UH115”, softening point 115° C.
Hydrogenated rosin-based resin (B3): hydrogenated rosin ester-based resin, available from Arakawa Chemical Industries, Ltd., trade name “KE-311”, softening point of 90 to 100° ° C. (ring and ball method)
Non-hydrogenated terpene phenolic resin: available from Yasuhara Chemical Co., Ltd., trade name “T115”, softening point of 115° C.
Non-hydrogenated rosin-based resin: polymerized rosin ester, available from Harima Chemicals, Inc., trade name “PCJ”, softening point of 118 to 128° C.

### Examples 1 to 5 and Comparative Examples 1 to 5

### Production of Energy-Beam-Crosslinkable Pressure Sensitive Adhesive Composition

Components were blended according to the composition (unit: parts by mass) shown in Table 1 and kneaded at 130° ° C. for 20 minutes under a nitrogen purge using a heating kneader, and an energy-beam-crosslinkable pressure sensitive adhesive composition was obtained.

### Production of First Pressure Sensitive Adhesive Sheet

The energy-beam-crosslinkable pressure sensitive adhesive composition obtained in the above was applied in a heat-melted state on a transparent poly(ethylene terephthalate) film (thickness: 50 μm) used as a substrate using a die coater. Thus, a first pressure sensitive adhesive sheet having an energy-beam-crosslinkable pressure sensitive adhesive composition layer composed of the energy-beam-crosslinkable pressure sensitive adhesive composition on the substrate was obtained.

### Production of Second Pressure Sensitive Adhesive Sheet

The energy-beam-crosslinkable pressure sensitive adhesive composition layer of the first pressure sensitive adhesive sheet obtained above was irradiated with ultraviolet light from the exposed surface side using a high-pressure mercury lamp (available from Eye Graphics Co., Ltd.) under a condition of an integrated amount of light of 30 mJ/cm² in the UV-C region. Thus, a pressure sensitive adhesive layer was formed by energy beam crosslinking the energy-beam-crosslinkable pressure sensitive adhesive composition layer included in the first pressure sensitive adhesive sheet. Then, a release-treated surface of a release liner (thickness: 38 μm) was bonded to the surface of the pressure sensitive adhesive layer, the surface being on the opposite side to the substrate, and a second pressure sensitive adhesive sheet having the substrate, the pressure sensitive adhesive layer, and the release liner in this order was obtained.

### Production of Substrate-Less Pressure Sensitive Adhesive Sheet

A substrate-less pressure sensitive adhesive sheet having the release liner, the pressure sensitive adhesive layer, and the release liner in this order, which was a second pressure sensitive adhesive sheet, was obtained by the same method as in the production of the first pressure sensitive adhesive sheet and the production of the second pressure sensitive adhesive sheet except that the substrate in the production of the first pressure sensitive adhesive sheet was changed to a release liner (thickness: 38 μm).

### Evaluation Method

The second pressure sensitive adhesive sheet and the substrate-less pressure sensitive adhesive sheet obtained in each example were evaluated by the methods shown below. In the following descriptions, the description “pressure sensitive adhesive sheet” refers to the second pressure sensitive adhesive sheet.

### Measurement of Gel Fraction

The gel fraction of the pressure sensitive adhesive layer in the substrate-less pressure sensitive adhesive sheet obtained in each example was measured by the method shown below.

The release liners on both sides were removed from the substrate-less pressure sensitive adhesive sheet obtained in each example, and only the pressure sensitive adhesive layer was taken out. Hereinafter, the pressure sensitive adhesive layer taken out is referred to as the “measurement object”.

Next, the measurement object taken out was wrapped in a polyester mesh (mesh size 200) whose mass had been measured in advance, and a test sample was prepared. The mass of the test sample was weighed with a precision balance, and the mass of only the measurement object before immersion was calculated by subtracting the mass of the polyester mesh from the measured value. This measured mass of the measurement object was given as M1.

Next, the test sample was immersed in ethyl acetate at room temperature (23° C.) for 72 hours. The test sample was taken out after immersion, dried in an oven at 120° C. for 2 hours, and then allowed to stand in an environment at a temperature of 23° C. and a relative humidity of 50% for 24 hours. The mass of the test sample after drying was weighed with a precision balance, and the mass of only the measurement object after immersion and drying was calculated by subtracting the mass of the polyester mesh from the measured value. This measured mass of the measurement object was given as M2.

The gel fraction was calculated by the following equation from the value of the mass M1 of the measurement object before immersion and the value of the mass M2 of the measurement object after immersion and drying.

$$Gel fraction ( mass \% ) = ( M 2 / M 1 ) \times 100$$

### Measurement of Peel Strength

After the release liner was peeled off from the pressure sensitive adhesive sheet obtained in each example, the exposed adhesive surface was pressure-bonded to a polyethylene plate used as an adherend at room temperature (23° C.) by reciprocating a 2-kg roller once in accordance with JIS Z 0237: 2009. After pressure-bonding, the material was allowed to stand in an environment of 23° C. and 50% RH (relative humidity) for 30 minutes and obtained as a sample for peel strength measurement.

The sample for peel strength measurement prepared in the above was measured for peel strength at a tensile speed of 300 mm/min by a 180° peeling method in accordance with JIS Z 0237: 2009 using a tensile tester (available from A & D Company, Limited, product name “Tensilon (trade name)”) in an environment of 23° ° C. and 50% RH (relative humidity).

### Evaluation of Holding Power

The holding power of the pressure sensitive adhesive sheet was measured in accordance with JIS Z 0237: 2009 by the following procedure.

The pressure sensitive adhesive sheet obtained in each example was cut into a 25-mm-wide strip, the release liner was peeled off, and the exposed adhesive surface of the pressure sensitive adhesive sheet was pressure-bonded to a stainless steel plate used as an adherend by reciprocating a 2-kg roller five times in accordance with JIS Z 0237: 2009. After pressure-bonding, the material was allowed to stand in an environment of 23° C. and 50% RH (relative humidity) for 15 minutes and obtained as a sample for holding power measurement.

The sample for holding power measurement prepared in the above was transferred into a thermostatic chamber at 40° C., a weight was attached to the pressure sensitive adhesive sheet to apply a constant load of 1 kgf in the vertical direction, the pressure sensitive adhesive sheet was tested for a maximum of 30000 seconds, and the holding power of the pressure sensitive adhesive sheet was evaluated according to the following criteria.
A: The pressure sensitive adhesive sheet was not displaced or did not fall 30000 seconds after the start of the test.
F: Within 30000 seconds from the start of the test, the pressure sensitive adhesive layer underwent cohesive failure, and the pressure sensitive adhesive sheet fell.

### Measurement of Haze

The release liner was peeled off from the pressure sensitive adhesive sheet obtained in each example, and the exposed pressure sensitive adhesive layer was laminated on glass, and this was obtained as a sample for measurement. The sample for measurement was measured for haze (%) in accordance with JIS K 7136: 2000 using a haze meter (available from Nippon Denshoku Industries Co., Ltd., product name “NDH5000”).

TABLE 1

| | | | | | | | | Comparative | | | | |
|---|---|---|---|---|---|---|---|---|---|---|---|---|
| | | | Examples | | | | | Examples | | | | |
| | | | 1 | 2 | 3 | 4 | 5 | 1 | 2 | 3 | 4 | 5 |
| Composition | Component | Energy-beam- | 100 | 100 | 100 | 100 | 100 | 100 | 100 | 100 | 100 | 100 |
| of pressure | (A) | crosslinkable acrylic | | | | | | | | | | |
| sensitive | | resin | | | | | | | | | | |
| adhesive | Component | Styrene-based resin | 30 | 30 | 20 | 30 | 40 | | | | | |
| composition | (B) | (B1) | | | | | | | | | | |
| | | Hydrogenated | | 10 | 20 | | | | | | 30 | |
| | | terpene phenolic | | | | | | | | | | |
| | | resin (B2) | | | | | | | | | | |
| | | Hydrogenated rosin- | | | | 10 | | | | | | 30 |
| | | based resin (B3) | | | | | | | | | | |
| | | Non-hydrogenated | | | | | | | 30 | | | |
| | | terpene phenolic | | | | | | | | | | |
| | | resin | | | | | | | | | | |
| | | Non-hydrogenated | | | | | | | | 30 | | |
| | | rosin-based resin | | | | | | | | | | |

| | | | | | | | | | | | |
|---|---|---|---|---|---|---|---|---|---|---|---|
| Evaluation | Gel fraction [mass %] | 56 | 52 | 53 | 49 | 70 | 73 | 25 | 21 | 30 | 30 |
| results | Peel strength (23° C.) [N/25 mm] | 4.3 | 7.2 | 7.0 | 7.2 | 7.5 | 3.0 | 8.0 | 7.5 | 7.5 | 6.8 |
| | Holding power (40° C.) | A | A | A | A | A | A | F | F | F | F |
| | Haze [%] | 5.8 | 3.0 | 2.5 | 3.3 | 12.5 | 1.8 | 2.5 | 2.3 | 2.8 | 2.3 |

Table 1 shows that the pressure sensitive adhesive sheets obtained in Examples 1 to 5 had good peel strength and were not displaced and did not fall in the holding power test, and had high holding power.

On the other hand, the pressure sensitive adhesive sheet of Comparative Example 1, to which a tackifier was not added, failed to obtain sufficient peel strength. The pressure sensitive adhesive sheets of Comparative Examples 2 to 5, in which the styrene-based resin (B1) was not used as a tackifier, all had poor holding power.

### REFERENCE SIGNS LIST

1 Energy-beam-crosslinkable pressure sensitive adhesive composition layer
2, 2a, 2b Release liner
3 Pressure sensitive adhesive layer
4 Substrate
10a, 20a, 30a First pressure sensitive adhesive sheet
10b, 20b, 30b Second pressure sensitive adhesive sheet

1. An energy-beam-crosslinkable pressure sensitive adhesive composition, comprising:
an acrylic resin (A) having energy beam crosslinkability; and
a tackifier (B),
wherein the tackifier (B) comprises a styrene-based resin (B1).

2. The energy-beam-crosslinkable pressure sensitive adhesive composition according to claim 1, wherein a content of the styrene-based resin (B1) is from 1 to 40 parts by mass per 100 parts by mass of the acrylic resin (A) having energy beam crosslinkability.

3. The energy-beam-crosslinkable pressure sensitive adhesive composition according to claim 1, wherein the tackifier (B) further comprises one or more selected from the group consisting of a hydrogenated terpene phenolic resin (B2) and a hydrogenated rosin-based resin (B3).

4. The energy-beam-crosslinkable pressure sensitive adhesive composition according to claim 3, wherein a content of the one or more selected from the group consisting of the hydrogenated terpene phenolic resin (B2) and the hydrogenated rosin-based resin (B3) is from 1 to 39 parts by mass per 100 parts by mass of the acrylic resin (A) having energy beam crosslinkability.

5. The energy-beam-crosslinkable pressure sensitive adhesive composition according to claim 1, wherein a total content of the tackifier (B) is from 5 to 40 parts by mass per 100 parts by mass of the acrylic resin (A) having energy beam crosslinkability.

6. The energy-beam-crosslinkable pressure sensitive adhesive composition according to claim 1, wherein the acrylic resin (A) having energy beam crosslinkability is an acrylic resin comprising a benzophenone structure in a side chain.

7. The energy-beam-crosslinkable pressure sensitive adhesive composition according to claim 1, wherein the styrene-based resin (B1) is a homopolymer of styrene-based monomers.

8. A pressure sensitive adhesive sheet comprising an energy-beam-crosslinkable pressure sensitive adhesive composition layer comprising the energy-beam-crosslinkable pressure sensitive adhesive composition of claim 1 on a substrate or a release liner.

9. A method for producing the pressure sensitive adhesive sheet of claim 8, comprising:
melt-kneading the acrylic resin (A) having energy beam crosslinkability and the tackifier (B) to obtain the energy-beam-crosslinkable pressure sensitive adhesive composition; and
forming the energy-beam-crosslinkable pressure sensitive adhesive composition layer by applying the energy-beam-crosslinkable pressure sensitive adhesive composition in a melted state on the substrate or the release liner.

10. A crosslinked pressure sensitive adhesive obtained by irradiating the energy-beam-crosslinkable pressure sensitive adhesive composition of claim 1 with an energy beam.

11. The crosslinked pressure sensitive adhesive according to claim 10, wherein a gel fraction is from 30 to 85 mass %.

12. The crosslinked pressure sensitive adhesive according to claim 10, wherein a haze measured in accordance with JIS K 7136: 2000 is 8% or less.

13. A method for producing the crosslinked pressure sensitive adhesive of claim 10, the method comprising:
irradiating the energy-beam-crosslinkable pressure sensitive adhesive composition with an energy beam.

14. A pressure sensitive adhesive sheet comprising a pressure sensitive adhesive layer comprising the crosslinked pressure sensitive adhesive of claim 10 on a substrate or a release liner.

15. A method for producing the pressure sensitive adhesive sheet of claim 14, the method comprising:
forming an energy-beam-crosslinkable pressure sensitive adhesive composition layer comprising the energy-beam-crosslinkable pressure sensitive adhesive composition on the substrate or the release liner; and
irradiating the energy-beam-crosslinkable pressure sensitive adhesive composition layer with an energy beam.

16. The method for producing the pressure sensitive adhesive sheet according to claim 15, further comprising:
melt-kneading the acrylic resin (A) having energy beam crosslinkability and the tackifier (B) to obtain the energy-beam-crosslinkable pressure sensitive adhesive composition; and
forming the energy-beam-crosslinkable pressure sensitive adhesive composition layer by applying the energy-beam-crosslinkable pressure sensitive adhesive composition in a melted state on the substrate or the release liner.
